(19) United States
(12) Patent Application Publication
(10) Pub. No.: US 2017/0192549 A1
(43) Pub. Date: Jul. 6, 2017

(54) TOUCH PANEL CONTROLLER, STYLUS PEN, TOUCH PANEL SYSTEM, AND ELECTRONIC DEVICE

(71) Applicant: SHARP KABUSHIKI KAISHA, Osaka (JP)

(72) Inventors: Takahiro KATAYAMA, Osaka (JP); Michiaki TAKEDA, Osaka (JP); Mamoru TAKAYA, Osaka (JP)

(73) Assignee: SHARP KABUSHIKI KAISHA, Osaka (JP)

(21) Appl. No.: 15/313,142

(22) PCT Filed: May 18, 2015
(86) PCT No.: PCT/JP2015/064239

§ 371 Date: Nov. 22, 2016

(30) Foreign Application Priority Data
Jun. 30, 2014 (JP) 2014-135316

(51) Int. Cl. G06F 3/041; G06F 3/048; G06K 11/06; G06F 3/033; G06F 3/044; G06F 3/0354

(52) U.S. Cl. CPC G06F 3/041; G06F 3/044; G06F 3/03545; G06K 11/06; G06F 3/033; G06F 3/048

(57) ABSTRACT

Driving of a stylus pen is satisfactorily controlled even when the touch panel controller and the stylus pen are not connected through a wire. A touch panel (2) is driven by a touch panel controller (4), and is given with an input operation from a stylus pen (3) that is able to transmit and receive information to and from the touch panel controller (4) via wireless communication. The touch panel controller (4) includes a timing generator (14) that generates a synchronization signal to synchronize drive timing of the stylus pen (3) and drive timing of the touch panel (2) with each other, and an information signal generating unit (19) that generates an information signal representing a drive state of the touch panel (2). The information signal is transferred from the touch panel controller (4) to the stylus pen (3) subsequent to the synchronization signal.

### TECHNICAL FIELD

The present invention relates to a touch panel controller and a stylus pen.

### BACKGROUND ART

In recent years, touch panels have increasingly become inevitable as input means for electric devices. Touch panels are generally used as input means for a variety of devices ranging from comparatively large devices such as TVs, monitors, and white boards, to comparatively small devices such as smartphones and tablet terminals.

There are further proposed many touch panel systems each of which includes a dedicated touch pen (an electric pen or a stylus pens) capable of providing not only information regarding a touch position, but also additional information (e.g., information indicating whether a button is in a pushed state or not, and/or writing pressure), such that information can be input using not only a finger, but also the dedicated touch pen, and which can realize the inputting of information in more various modes with higher accuracy.

For example, Patent Literature (PTL) 1 discloses a touch panel system capable of accurately detecting individual touch positions even in a state where touch operations using one or more electric pens and one or more fingers are performed at the same time.

The touch panel system disclosed in PTL 1 includes a plurality of transmission electrodes (first signal lines) to which a drive signal and a pen synchronization signal are applied from a transmission unit, a plurality of reception electrodes (second signal lines) that output response signals to a reception unit, an electric pen (touch pen), and a control unit. The electric pen sends a pen identification signal to the reception electrode in response to detection of the pen synchronization signal applied to the transmission electrode. The control unit controls drive timing at which the transmission unit applies the drive signal and the pen synchronization signal to the transmission electrode, and detects a touch position on the basis of detection data that is output from the reception unit.

According to the configuration described above, the drive timing of the electric pen and the drive timing at which the control unit drives the transmission electrode can be synchronized with each other, and an indicating member having made a touch operation can be discriminated on the basis of the pen identification signal. As a result, the touch operation by the finger and the touch operation through the electric pen can be detected at the same time.

### CITATION LIST

### Patent Literature

PTL 1: Japanese Patent Publication “Japanese Unexamined Patent Application Publication No. 2012-22543 (laid open on Feb. 2, 2012)”

### SUMMARY OF INVENTION

### Technical Problem

As disclosed in PTL 1, in a touch panel system including a stylus pen (dedicated touch pen) and detecting a touch position of, e.g., a finger by detecting change of an electrostatic capacitance, the drive timing of the stylus pen and the drive timing of a touch panel controller for driving a touch panel are needed to be synchronized with each other in order that detection of a finger touch and detection of a signal generated by the dedicated touch pen can be performed at the same time with the same mechanism.

Furthermore, in the touch panel system using an external device, such as a stylus pen, in a combined manner, it is needed to transmit information, such as a control signal, from the touch panel controller to the external device in order to control the operation of the external device from the touch panel controller.

However, the touch panel system disclosed in PTL 1 has the problem that there is no way of transferring information from the touch panel controller to the stylus pen.

Thus, the touch panel system disclosed in PTL 1 has the problem that, unless the touch panel controller and the stylus pen are connected to each other through a wire (cable), the driving of the stylus pen cannot be controlled in a satisfactory manner.

The present invention has been made to solve the above-described problems, and an object of the present invention is to provide a touch panel controller capable of satisfactorily controlling driving of a stylus pen even when the touch panel controller and the stylus pen are not connected through a wire.

### Solution to Problem

To solve the above-described problems, according to one aspect of the present invention, there is provided a touch panel controller for driving a touch panel, the touch panel being given with an input operation from a stylus pen that is able to transmit and receive information to and from the touch panel controller via wireless communication, the touch panel controller including a synchronization signal generating unit that generates a synchronization signal to synchronize drive timing of the stylus pen and drive timing of the touch panel with each other, and an information signal generating unit that generates an information signal representing a drive state of the touch panel, wherein the information signal is transferred from the touch panel controller to the stylus pen subsequent to the synchronization signal.

To solve the above-described problems, according to another aspect of the present invention, there is further provided a stylus pen for applying an input operation to a touch panel, the touch panel being driven by a touch panel controller, the stylus pen being able to transmit and receive information to and from the touch panel controller via wireless communication, the stylus pen including a synchronization signal detecting unit that detects a synchronization signal to synchronize drive timing of the stylus pen and drive timing of the touch panel with each other, and an information signal detecting unit that detects an information signal representing a drive state of the touch panel, wherein the synchronization signal and the information signal are generated by the touch panel controller, and the information signal is transferred from the touch panel controller to the stylus pen subsequent to the synchronization signal.

### Advantageous Effects of Invention

With the touch panel controller according to one aspect of the present invention, an advantageous effect is obtained in that the driving of the stylus pen can be satisfactorily controlled without connecting the touch panel controller and the stylus pen through a wire.

With the stylus pen according to another aspect of the present invention, a similar advantageous effect to that obtained with the touch panel controller according to the one aspect of the present invention is also obtained.

### BRIEF DESCRIPTION OF DRAWINGS

FIG. 1 is a functional block diagram schematically illustrating a configuration of a touch panel system according to Embodiment 1 of the present invention.

FIG. 2 is a wiring diagram illustrating a configuration of a touch panel in the touch panel system according to Embodiment 1 of the present invention.

FIG. 3 is a sectional view illustrating a configuration of a stylus pen in the touch panel system according to Embodiment 1 of the present invention.

FIG. 4 is a functional block diagram illustrating a configuration of a touch panel system according to Embodiment 2 of the present invention.

FIG. 5 is a wiring diagram illustrating a configuration of a touch panel in the touch panel system according to Embodiment 2 of the present invention.

FIG. 6 is a circuit diagram illustrating a configuration of a multiplexer in the touch panel system according to Embodiment 2 of the present invention.

FIGS. 7(a) and 7(b) schematically illustrate different drive states in the touch panel system according to Embodiment 2 of the present invention.

FIG. 8(a) illustrates, by way of example, a 3-bit information signal “000” coded with Manchester encoding, and FIG. 8(b) illustrates, by way of example, a 3-bit information signal “111” coded with Manchester encoding.

FIG. 9 illustrates correspondence relation between a drive operation of the touch panel controller and a drive operation of the stylus pen in the touch panel system according to Embodiment 2 of the present invention.

FIG. 10 is a functional block diagram illustrating a configuration of a mobile phone according to Embodiment 3 of the present invention.

### DESCRIPTION OF EMBODIMENTS

### Embodiment 1

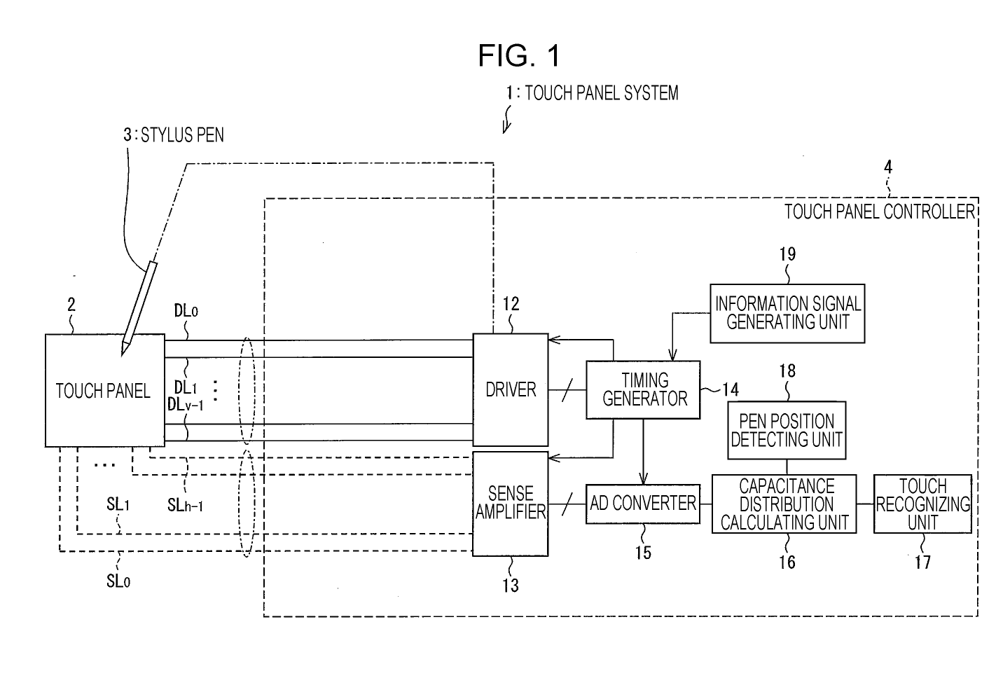

Embodiment 1 of the present invention will be described below with reference to FIGS. 1 to 3.

(Touch Panel System 1)

FIG. 1 is a functional block diagram schematically illustrating a configuration of a touch panel system 1 according to Embodiment 1. The touch panel system 1 includes a touch panel 2, a stylus pen 3, and a touch panel controller 4.

In the touch panel system 1, the stylus pen 3 is employed by a user to perform an input operation on the touch panel 2. The touch panel controller 4 drives the touch panel 2 and the stylus pen 3.

The touch panel 2 preferably has such a size as allowing the user to keep the hand rested on the touch panel 2 while gripping the stylus pen 3. However, the touch panel 2 may have a size substantially equal to that of, e.g., a smartphone.

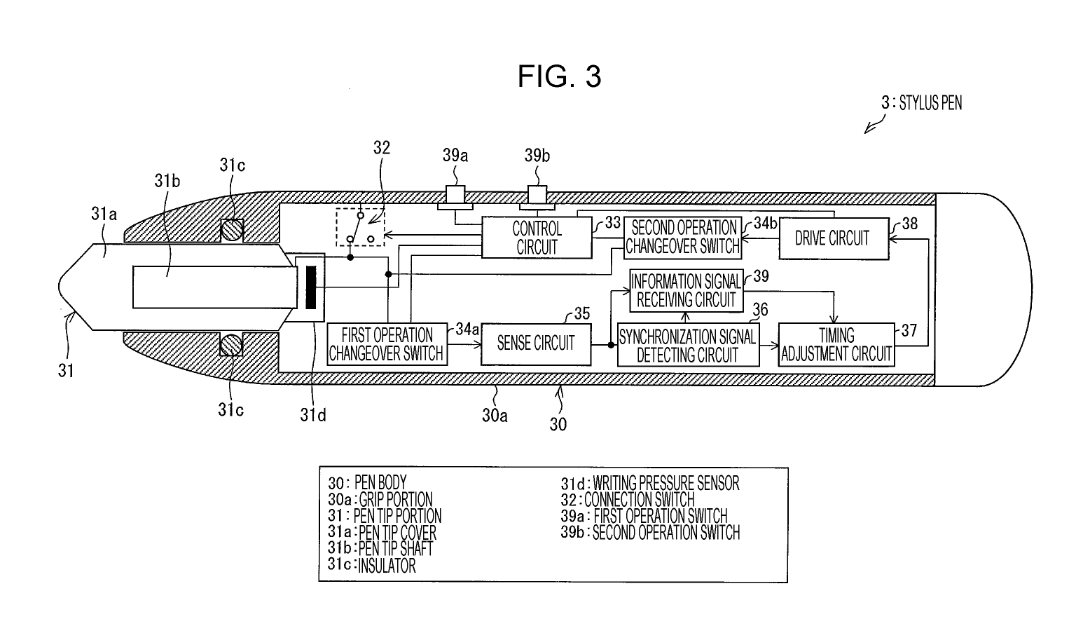

The stylus pen 3 is a touch pen including a conductor that is to be brought into contact with the touch panel 2. Furthermore, the stylus pen 3 has the function of inputting and outputting various signals. A detailed configuration of the stylus pen will be described later (with reference to FIG. 3).

The stylus pen 3 drives a pen tip portion 31 of the stylus pen 3 with a drive signal that is the same as a drive signal (waveform) used to drive a virtual drive line DLᵥ by the touch panel controller 4.

Furthermore, the stylus pen 3 changes an electrostatic capacitance on a touch surface of the touch panel 2 such that the touch panel controller 4 can detect change of the electrostatic capacitance through sense lines SL₀ to SLₕ₋₁, thereby detecting additional information indicating, e.g., a state where a button disposed on the stylus pen 3 is pushed by the user or not, and writing pressure.

The drive signal for the stylus pen is not always required to be the signal correspondent to the virtual drive line DLᵥ insofar as it is other than drive signals applied to drive lines DL₀ to DLᵥ₋₁ that are connected to the touch panel 2. For example, a synchronization signal corresponding to any one of virtual drive lines subsequent DLᵥ₊₂ may be used as the drive signal for the stylus pen.

The stylus pen 3 includes a synchronization signal detecting circuit 36 (synchronization signal detecting unit), and it is able to detect (receive) a synchronization signal (synchronization waveform) that is generated by a timing generator 14 (synchronization signal generating unit) in the touch panel controller 4.

(Touch Panel 2)

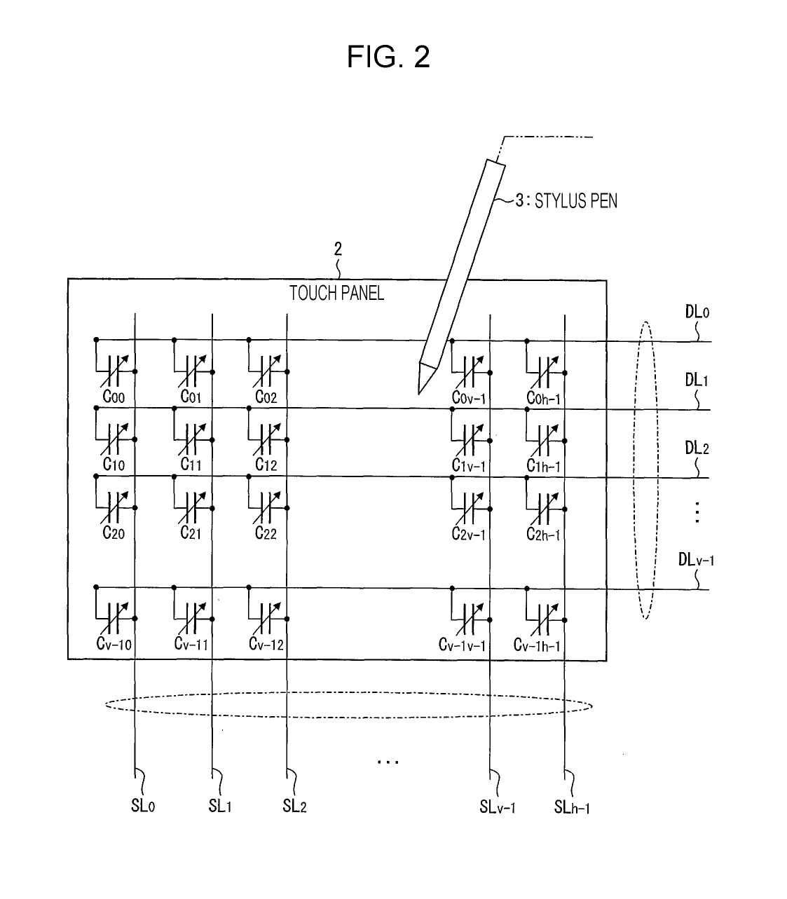

FIG. 2 is a wiring diagram illustrating a configuration of the touch panel 2. The touch panel 2 includes (i) a number v (v is an integer satisfying v≧0) of drive lines DL₀ to DLᵥ₋₁ that are arranged to extend in a horizontal direction parallel to one another, and (ii) a number h (h is an integer satisfying h≧0) of sense lines SL₀ to SLₕ₋₁ that are arranged to extend in a vertical direction parallel to one another.

Furthermore, a number (v×h) of electrostatic capacitances C₀₀ to Cᵥ₋₁ₕ₋₁ are generated at intersect points between the drive lines DL₀ to DLᵥ₋₁ and the sense lines SL₀ to SLₕ₋₁. Here, the electrostatic capacitance generated at an intersect point between a drive line DLₚ (p is an integer satisfying 0≦p≦v−1) and a sense line SL_{q} (q is an integer satisfying 0≦q≦h−1) is denoted by the electrostatic capacitance C_{pq}.

FIG. 2 illustrates the configuration that the drive lines DL₀ to DLᵥ₋₁ and the sense lines SL₀ to SLₕ₋₁ intersect perpendicularly. However, the drive lines DL₀ to DLᵥ₋₁ and the sense lines SL₀ to SLₕ₋₁ are not always required to intersect perpendicularly insofar as both the lines are arranged in a state intersecting each other.

Additionally, v and h may be equal to or different from each other. This embodiment is described, by way of example, in connection with the case of v≦h.

(Touch Panel Controller 4)

A configuration of the touch panel controller 4 will be described below with reference to FIG. 1. The touch panel controller 4 includes a driver 12, a sense amplifier 13, a timing generator 14, an AD (Analog-Digital) converter 15, a capacitance distribution calculating unit 16, a touch recognizing unit 17, a pen position detecting unit 18, and an information signal generating unit 19.

The number v of drive lines DL₀ to DLᵥ₋₁ are connected to the driver 12. The driver 12 applies voltages to the drive lines DL₀ to DLᵥ₋₁.

The number h of sense lines SL₀ to SLₕ₋₁ are connected to the sense amplifier 13. The sense amplifier 13 reads linear sum signals from the sense lines SL₀ to SLₕ₋₁ when the drive lines DL₀ to DLᵥ₋₁ are driven. The sense amplifier 13 then supplies the linear sum signals to the AD converter 15.

The linear sum signals are given corresponding to (i) signals representing initial charges that correspond to the electrostatic capacitances C₀₀ to Cᵥ₋₁ₕ₋₁ of the touch panel 2, and (ii) signals representing charges in a touched state, the charges corresponding to electrostatic capacitances between the stylus pen 3 and the sense lines SL₀ to SLₕ₋₁ in the touched state.

When the stylus pen 3 is placed close to a certain position of the touch panel 2 in a state where charges corresponding to the electrostatic capacitances are detected in drive periods of the drive lines DL₀ to DLᵥ₋₁, the electrostatic capacitance at the relevant position is changed.

Accordingly, the changed electrostatic capacitance can be detected as the linear sum signal. The touch panel 2 of ordinary type is constituted such that, when the stylus pen 3 is placed close to a certain position of the touch panel 2, the electrostatic capacitance at the relevant position is increased.

The timing generator 14 generates a signal specifying an operation of the driver 12, a signal specifying an operation of the sense amplifier 13, and a signal specifying an operation of the AD converter 15, and supplies the generated signals to the driver 12, the sense amplifier 13, and the AD converter 15, respectively.

Moreover, the timing generator 14 generates a synchronization signal and applies the synchronization signal to the touch panel controller 4. The synchronization signal in this embodiment has a periodic waveform in a pseudo-irregular sequence coded with Manchester encoding.

The touch panel controller 4 drives the drive lines DL₀ to DLᵥ₋₁ with the synchronization signal.

The AD converter 15 executes AD conversion of the linear sum signals applied from the sense amplifier 13, and supplies the linear sum signals after the AD conversion to the capacitance distribution calculating unit 16.

The capacitance distribution calculating unit 16 calculates, on the basis of the linear sum signals and a code sequence based on the driving, (i) a distribution of the electrostatic capacitances on the touch panel 2, and (ii) a distribution of the electrostatic capacitances between the stylus pen 3 and the sense lines SL₀ to SLₕ₋₁.

The capacitance distribution calculating unit 16 supplies the distribution of the electrostatic capacitances on the touch panel 2 to the touch recognizing unit 17. Furthermore, the capacitance distribution calculating unit 16 supplies the distribution of the electrostatic capacitances between the stylus pen 3 and the sense lines SL₀ to SLₕ₋₁ to the pen position detecting unit 18.

The touch recognizing unit 17 recognizes a touch position on the touch panel 2 (i.e., a position where an input operation is performed on the touch panel 2 by the stylus pen 3) on the basis of the distribution of the electrostatic capacitances on the touch panel 2, the above distribution being supplied from the capacitance distribution calculating unit 16.

The pen position detecting unit 18 detects a position of the stylus pen 3 along the drive lines DL₀ to DLᵥ₋₁ on the basis of the distribution of the electrostatic capacitances between the stylus pen 3 and the sense lines SL₀ to SLₕ₋₁.

An operation of the information signal generating unit 19 will be described later.

(Stylus Pen 3)

FIG. 3 is a sectional view illustrating a configuration of the stylus pen 3. The detailed configuration of the stylus pen 3 will be described below with reference to FIG. 3.

This embodiment is described, by way of example, in connection with the configuration that a writing pressure sensor 31d is disposed in the stylus pen 3. However, the writing pressure sensor 31d is not always required to be disposed in the stylus pen 3.

A pen body 30 of the stylus pen 3 includes a conductive grip portion 30a formed in a substantially cylindrical shape such that the user can grip the stylus pen 3. A pen tip portion 31 is disposed at a tip of the pen body 30, and is pressed against the touch panel 2 in the touch operation.

The pen tip portion 31 includes a pen tip cover 31a, a pen tip shaft 31b, an insulator 31c, and the writing pressure sensor 31d. The pen tip cover 31a is made of an insulating material. The pen tip shaft 31b is made of a conductive material (e.g., a metal or a conductive synthetic resin material). The insulator 31c holds the pen tip cover 31a in a manner allowing the pen tip cover 31a to freely move forward and backward in an axial direction.

The writing pressure sensor 31d is disposed on the inner side of the pen tip shaft 31b. The writing pressure sensor 31d is constituted as a semiconductor piezoresistance pressure sensor, for example, and it includes a semiconductor strain gauge formed on a surface of a diaphragm (not illustrated).

Accordingly, when the pen tip cover 31a is pressed against the touch panel 2 in the touch operation, the pen tip shaft 31b is pushed inward through the pen tip cover 31a and is pressed against the surface of the diaphragm of the writing pressure sensor 31d.

Therefore, change of electrical resistance attributable to the piezoelectric effect occurs upon deformation of the pressed diaphragm. In the writing pressure sensor 31d, the change of the electric resistance is converted to an electrical signal. As a result, the writing pressure applied from the stylus pen 3 can be detected.

It is to be noted that the principle for detecting the writing pressure is not always limited to one utilizing the piezoresistance effect, and that another detection principle can also be employed.

A connection switch 32, a control circuit 33, a first operation changeover switch 34a, a second operation changeover switch 34b, a sense circuit 35, a synchronization signal detecting circuit 36, a timing adjustment circuit 37, a drive circuit 38, and an information signal receiving circuit 39 (information signal detecting unit) are disposed inside the pen body 30.

This embodiment is described, by way of example, in connection with the configuration that the connection switch 32 is disposed in the stylus pen 3. However, the connection switch 32 may be omitted. When the connection switch 32 is omitted, the grip portion 30a is connected to a reference potential (GND), for example.

The connection switch 32 is an electronic switch made of a FET (Field Effect Transistor), for example. An on/off changeover operation of the connection switch 32 is controlled by the control circuit 33.

When the connection switch 32 is in an off-state, the pen tip shaft 31b is electrically cut off from the grip portion 30a. In this case, because the electrostatic capacitance of the pen tip portion 31 is very small, it is difficult for the stylus pen 3 to obtain the synchronization signal of the touch panel 2 in the touch panel system 1 even when the pen tip cover 31a is positioned close to the touch panel 2.

On the other hand, when the connection switch 32 is in an on-state, the pen tip shaft 31b is electrically connected to the grip portion 30a. Furthermore, a human body is electrically connected to the pen tip shaft 31b through the grip portion 30a.

In the above case, because the human body has a comparatively large electrostatic capacitance, the stylus pen 3 can easily obtain the synchronization signal of the touch panel 2 when the stylus pen 3 is positioned close to or brought into contact with the touch panel 2.

Moreover, the stylus pen 3 includes a first operation switch 39a and a second operation switch 39b each being of the push type, for example.

By depressing the first operation switch 39a and the second operation switch 39b to start operations, the functions assigned to the first operation switch 39a and the second operation switch 39b can be executed through the control circuit 33.

The function assigned to the first operation switch 39a is, for example, the eraser function. The eraser function can be turned on or off by the first operation switch 39a.

The function assigned to the second operation switch 39b is, for example, the right-click function of a mouse. The right-click function of the mouse can be turned on or off by the second operation switch 39b.

It is to be noted that the eraser function and the right-click function of the mouse are merely examples, and that the functions assigned to the first and second operation switches are not limited to the eraser function and the right-click function of the mouse. An additional operation switch may be disposed in the stylus pen 3 to add another function.

(Transmission and Reception of Signals Between Stylus Pen 3 and Touch Panel Controller 4)

In the touch panel system 1, the stylus pen 3 transmits and receives signals to and from the touch panel controller 4 in a wireless manner.

Furthermore, in the stylus pen 3, the pen tip portion 31 is driven by the drive circuit 38. The drive circuit 38 is a drive circuit similar to the driver 12 in the touch panel controller 4.

The drive lines DL₀ to DLᵥ₋₁ are driven by the driver 12 in accordance with the drive timing specified by the timing generator 14.

In order to satisfactorily perform transmission and reception of signals between the stylus pen 3 and the touch panel controller 4, it is hence further required in the stylus pen 3 that the drive circuit 38 performs the driving in synchronization with the timing at which the driver 12 drives the drive lines DL₀ to DLᵥ₋₁.

In consideration of the above point, the stylus pen 3 includes the sense circuit 35, the synchronization signal detecting circuit 36, and the timing adjustment circuit 37.

The sense circuit 35 obtains, from the touch panel controller 4, a signal (waveform) containing the synchronization signal that has been generated by the timing generator 14. The relevant signal contains a later-described information signal as well. The synchronization signal detecting circuit 36 detects the synchronization signal from the relevant signal.

The timing adjustment circuit 37 refers to the synchronization signal that has been detected in the synchronization signal detecting circuit 36, and generates a pen synchronization signal. As a result, timing of the pen synchronization signal can be matched with the timing of the synchronization signal generated in the timing generator 14.

The pen synchronization signal is applied to the drive circuit 38, thus enabling the drive circuit 38 to drive the pen tip portion 31 in synchronization with the timing at which the driver 12 drives the drive lines DL₀ to DLᵥ₋₁.

(Operation of Information Signal Generating Unit 19)

In order to satisfactorily control the operation of the stylus pen 3 from the touch panel controller 4, it is required to transmit information, e.g., a control signal, from the touch panel controller 4 to the stylus pen 3.

For example, by transmitting, as a control signal, information representing a drive state of the touch panel 2 from the touch panel controller 4 to the stylus pen 3, the stylus pen 3 can be satisfactorily controlled depending on the drive state of the touch panel 2. The above control signal may be called an information signal (information waveform).

The information signal may be a signal indicating, for example, whether the drive state of the touch panel 2 is in an active state or an idle state (namely, whether the touch panel 2 is driven or not).

Thus, the touch panel controller 4 includes the information signal generating unit 19 that generates the information signal representing the drive state of the touch panel 2. The stylus pen 3 includes the information signal receiving circuit 39 that receives the generated information signal.

An operation of the information signal generating unit 19 is first described. The information signal generating unit 19 refers to a signal generated by the timing generator 14 and specifying the operation of the driver 12, and recognizes whether the drive state of the touch panel 2 is the active state or the idle state. Then, the information signal generating unit 19 generates the information signal on the basis of a result of the recognition.

The information signal may be expressed as a digital signal. For example, the information signal may be expressed as (i) a signal “0” in the case of representing the active state, or (ii) a signal “1” in the case of representing the idle state.

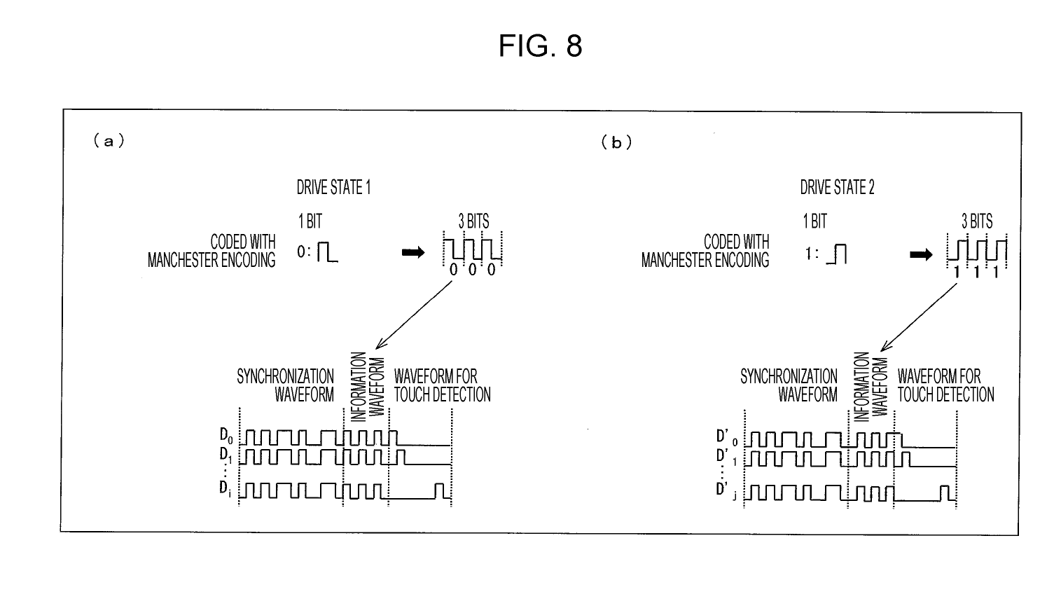

In this embodiment, the information signal is coded with Manchester encoding similarly to the above-described synchronization signal. For example, the signal “0” may be set corresponding to High→Low of the waveform, and the signal “1” may be set corresponding to Low→High of the waveform (see FIG. 8 described later).

Because the information signal is coded with the Manchester encoding, the information signal can be prevented from being maintained in a High or Low state for a long time. It is hence possible to reduce a DC component of the information signal, and to satisfactorily transfer the information signal via wireless communication.

However, an encoding method for the information signal is not necessarily limited to the Manchester encoding, and one of the other known encoding methods may be used instead. For example, the RZ (Return to Zero) method, the NRZ (Non Return to Zero) method, the NRZI (Non Return to Zero Inversion) method, the AMI (Alternate Mark Inversion) code method, or the CMI (Code Mark Inversion) code method may be used as the encoding method.

The information signal may be a 1-bit signal. From the viewpoint of error correction of the information signal, however, the information signal is preferably a multibit signal in which individual bits have equal values. In this embodiment, the information signal is a 3-bit signal.

Thus, the information signal is expressed, for example, as (i) a signal “000” in the case of representing the active state, and (ii) a signal “111” in the case of representing the idle state.

The bit number of the information signal is not limited to a particular number, i.e., 3 bits. The information signal may be N bits (N≧1), and N may be optionally determined by a person who designs the touch panel system 1.

The information signal generated by the information signal generating unit 19 is transferred from the touch panel controller 4 to the stylus pen 3 similarly to the above-described synchronization signal. The information signal is transferred from the touch panel controller 4 to the stylus pen 3 subsequent to the synchronization signal.

(Operation of Information Signal Receiving Circuit 39)

Operations in the stylus pen 3 are described next. The information signal receiving circuit 39 starts an operation of receiving the information signal with a trigger released upon detection of the synchronization signal by the synchronization signal detecting circuit 36. As a result, the information signal receiving circuit 39 can receive the information signal subsequent to the synchronization signal at proper timing.

When the information signal is a multibit signal, the information signal receiving circuit 39 may have the function of error correction. The information signal receiving circuit 39 may execute the error correction of the information signal by applying the rule of majority to the individual bits of the information signal.

When the information signal is a 1-bit signal, the information signal receiving circuit 39 is not necessarily required to have the error correction function. In order to execute the error correction of the information signal based on the rule of majority, the bit number of the information signal preferably satisfies N≧3.

The information signal receiving circuit 39 applies the received information signal to the timing adjustment circuit 37. The timing adjustment circuit 37 refers to the information signal and generates the pen synchronization signal corresponding to the drive state of the touch panel 2.

As a result, the drive circuit 38 can recognize whether the touch panel 2 is going to be driven in the active state or the idle state, and can generate the drive signal corresponding to the drive state of the touch panel 2.

(Advantageous Effect of Touch Panel System 1)

In the touch panel system 1 of this embodiment, the information signal generating unit 19 is disposed in the touch panel controller 4, and the information signal receiving circuit 39 is disposed in the stylus pen 3.

Accordingly, the information signal can be transferred from the touch panel controller 4 to the stylus pen 3 without connecting the touch panel controller 4 and the stylus pen 3 through a cable.

The information signal in this embodiment is a signal indicating, for example, whether the drive state of the touch panel 2 is the active state or the idle state. Therefore, the drive state of the stylus pen 3 can be set corresponding to the drive state of the touch panel 2 by applying the information signal to the stylus pen 3.

Thus, the touch panel system 1 of this embodiment has an advantageous effect that the driving of the stylus pen 3 can be satisfactorily controlled without connecting the touch panel controller 4 and the stylus pen 3 through a cable.

### Embodiment 2

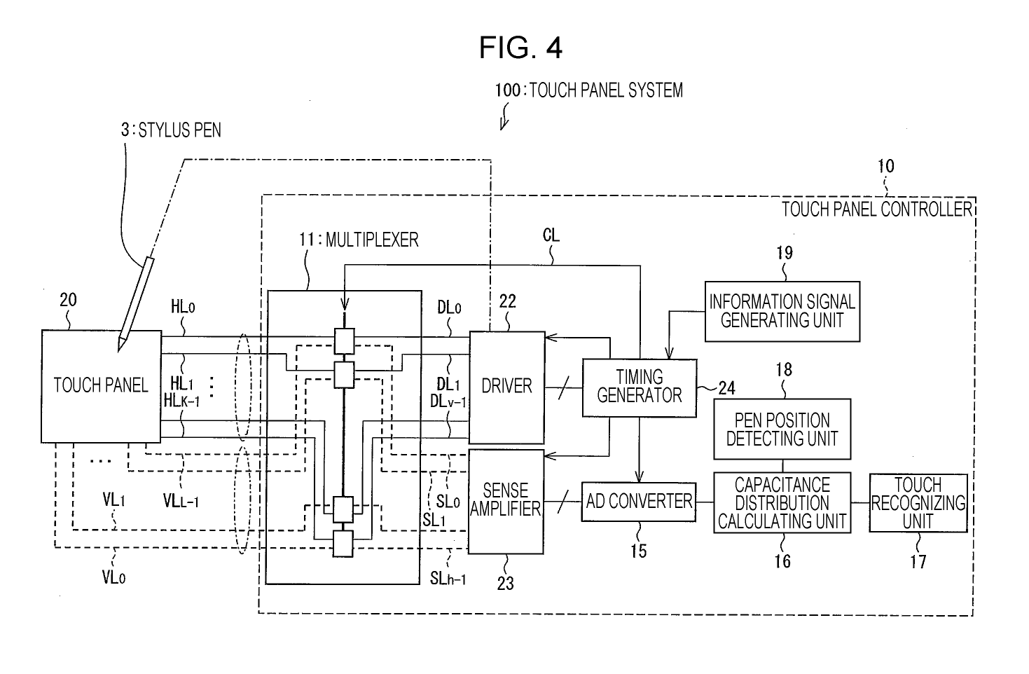

Another embodiment of the present invention will be described below with reference to FIGS. 4 to 9. For the sake of convenience in explanation, members having the same functions as the members described in the above embodiment are denoted by the same reference signs, and description of those members is omitted.

(Touch Panel System 100)

FIG. 4 is a functional block diagram schematically illustrating a configuration of a touch panel system 100 according to Embodiment 2. The touch panel system 100 includes a touch panel 20, a stylus pen 3, and a touch panel controller 10.

More specifically, the configuration of the touch panel system 100 according to Embodiment 2 is obtained by replacing (i) the touch panel 2 with the touch panel 20, and the touch panel controller 4 with the touch panel controller 10, respectively, in the touch panel system 1 according to Embodiment 1.

(Touch Panel 20)

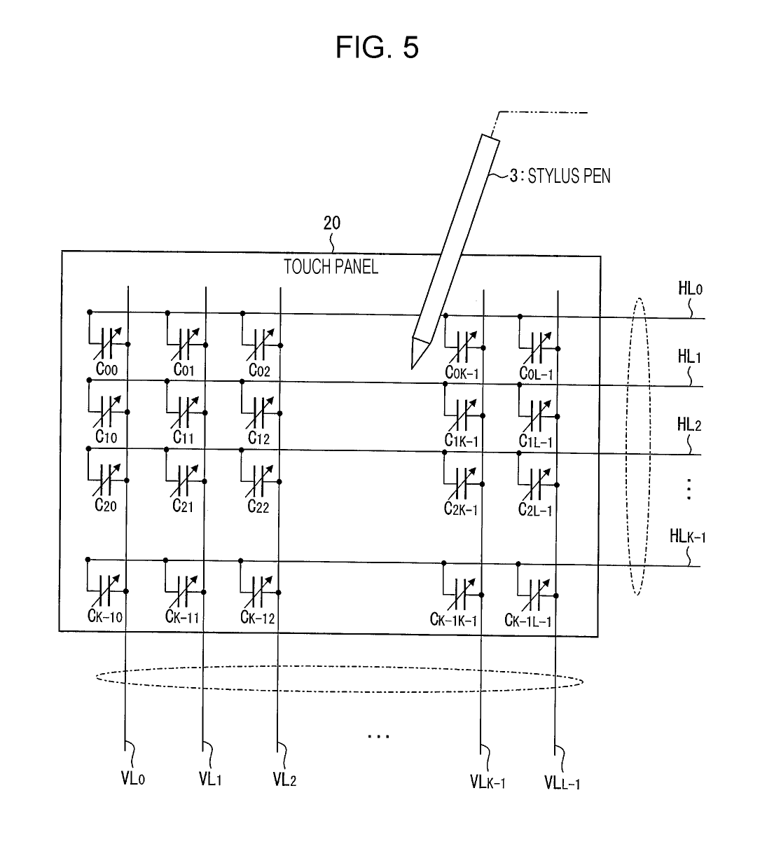

FIG. 5 is a wiring diagram illustrating a configuration of the touch panel 20. The touch panel 20 includes (i) a number K (K is an integer satisfying K≧0) of horizontal signal lines HL₀ to HL_{K-1} (first signal lines) that are arranged to extend in the horizontal direction parallel to one another, and (ii) a number L (L is an integer satisfying L≧0) of vertical signal lines VL₀ to VL_{L-1} (second signal lines) that are arranged to extend in the vertical direction parallel to one another.

In the touch panel 20, a number (K×L) of electrostatic capacitances C₀₀ to C_{K-1L-1} are generated at intersect points between the horizontal signal lines HL₀ to HL_{K-1} and the vertical signal lines VL₀ to VL_{L-1}. Additionally, K and L may be equal to or different from each other. This embodiment is described, by way of example, in connection with the case of K≦L.

The horizontal signal lines HL₀ to HL_{K-1} and the vertical signal lines VL₀ to VL_{L-1} are not always required to intersect perpendicularly insofar as both the lines are arranged in a state intersecting each other.

(Touch Panel Controller 10)

A configuration of the touch panel controller 10 will be described below with reference to FIG. 4. The touch panel controller 10 includes a multiplexer 11, a driver 22, a sense amplifier 23, a timing generator 24 (synchronization signal generating unit), an AD converter 15, a capacitance distribution calculating unit 16, a touch recognizing unit 17, a pen position detecting unit 18, and an information signal generating unit 19.

In the touch panel controller 10 in this embodiment, with the provision of the multiplexer 11, a signal line as an object to be driven (or an object to be sensed) can be changed over as described below. The following description is made only about members in relation to changeover of the signal line.

A number v (v is an integer satisfying 0≦v≦L, K) of drive lines DL₀ to DLᵥ₋₁ are connected to the driver 22. The driver 22 applies voltages to the drive lines DL₀ to DLᵥ₋₁ corresponding to driving of the horizontal signal lines H_{L0} to HL_{K-1} or the vertical signal lines VL₀ to VL_{L-1} in the touch panel 20.

A number h (h is an integer satisfying 0≦h≦L, K) of sense lines SL₀ to SLₕ₋₁ are connected to the sense amplifier 23. The sense amplifier 23 reads first linear sum signals from the sense lines SL₀ to SLₕ₋₁ when the horizontal signal lines HL₀ to HL_{K-1} are driven during a first signal line drive period. The sense amplifier 23 then supplies the first linear sum signals to the AD converter 15.

The first linear sum signals are given corresponding to (i) signals representing initial charges that correspond to the electrostatic capacitances C₀₀ to C_{K-1L-1} of the touch panel 20, and (ii) signals (first pen charge signals) representing charges in a touched state, the charges corresponding to electrostatic capacitances between the stylus pen 3 and the vertical signal lines VL₀ to VL_{L-1} in the touched state.

Furthermore, the sense amplifier 23 reads second linear sum signals from the sense lines SL₀ to SLₕ₋₁ when the vertical signal lines VL₀ to VL_{L-1} are driven during a second signal line drive period. The sense amplifier 23 then supplies the second linear sum signals to the AD converter 15.

The second linear sum signals are given corresponding to (i) the signals representing the initial charges that correspond to the electrostatic capacitances C₀₀ to C_{K-1L-1} of the touch panel 20, and (ii) signals (second pen charge signals) representing charges in the touched state, the charges corresponding to electrostatic capacitances between the stylus pen 3 and the horizontal signal lines HL₀ to HL_{K-1} in the touched state.

The AD converter 15 executes AD conversion of the first linear sum signals applied from the sense amplifier 23 during the first signal line drive period, and supplies the first linear sum signals after the AD conversion to the capacitance distribution calculating unit 16. Moreover, the AD converter 15 executes AD conversion of the second linear sum signals applied from the sense amplifier 23, and supplies the second linear sum signals after the AD conversion to the capacitance distribution calculating unit 16.

The capacitance distribution calculating unit 16 calculates, on the basis of the first linear sum signals, the second linear sum signals, and a code sequence based on the driving, (i) a distribution of the electrostatic capacitances on the touch panel 20, (ii) a distribution of the electrostatic capacitances between the stylus pen 3 and the vertical signal lines VL₀ to VL_{L-1}, and (iii) a distribution of the electrostatic capacitances between the stylus pen 3 and the horizontal signal lines HL₀ to HL_{K-1}.

The pen position detecting unit 18 detects a position of the stylus pen 3 along the horizontal signal lines HL₀ to HL_{K-1} on the basis of the distribution of the electrostatic capacitances between the stylus pen 3 and the vertical signal lines VL₀ to VL_{L-1}.

Furthermore, the pen position detecting unit 18 detects a position of the stylus pen 3 along the vertical signal lines VL₀ to VL_{L-1} on the basis of the distribution of the electrostatic capacitances between the stylus pen 3 and the number K of horizontal signal lines HL₀ to HL_{K-1}.

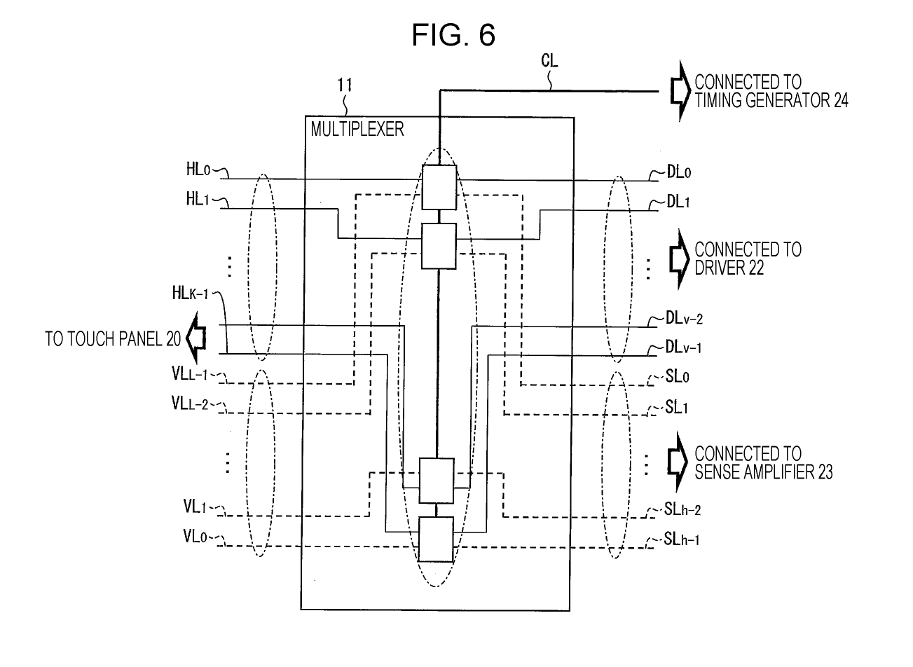

The multiplexer 11 is a connection changeover circuit that optionally changes over connections between a plurality of inputs and a plurality of outputs. A configuration of the multiplexer 11 will be described below with reference to FIG. 6. FIG. 6 is a circuit diagram illustrating the configuration of the multiplexer 11.

The multiplexer 11 changes over (i) a first connection state where the horizontal signal lines HL₀ to HL_{K-1} are connected to the drive lines DL₀ to DLᵥ₋₁, and the vertical signal lines VL₀ to VL_{L-1} are connected to the sense lines SL₀ to SLₕ₋₁, and (ii) a second connection state where the horizontal signal lines HL₀ to HL_{L-1} are connected to the sense lines SL₀ to SLₕ₋₁, and the vertical signal lines VL₀ to VL_{K-1} are connected to the drive lines DL₀ to DLᵥ₋₁.

Moreover, the multiplexer 11 is connected to the timing generator 24 through a control line CL. An operation of changing over the first connection state and the second connection state in the multiplexer 11 is controlled in accordance with a control signal that is applied from the timing generator 24 through the control line CL.

For example, when the control signal is “Low”, the multiplexer 11 establishes the first connection state. In this case, the horizontal signal lines HL₀ to HL_{K-1} are connected to the drive lines DL₀ to DLᵥ₋₁, and the vertical signal lines VL₀ to VL_{L-1} are connected to the sense lines SL₀ to SLₕ₋₁.

It is hence understood that, in the first connection state, the number v of horizontal signal lines HL₀ to HLᵥ₋₁ become objects to be driven, and the number h of vertical signal lines VL₀ to VLₕ₋₁ become objects to be sensed.

On the other hand, when the control signal is “High”, the multiplexer 11 establishes the second connection state. In this case, the horizontal signal lines HL₀ to HL_{K-1} are connected to the sense lines SL₀ to SLₕ₋₁, and the vertical signal lines VL₀ to VL_{L-1} are connected to the drive lines DL₀ to DLᵥ₋₁.

It is hence understood that, in the second connection state, the number h of vertical signal lines VL₀ to VLₕ₋₁ become objects to be driven, and the number v of horizontal signal lines HL₀ to HLᵥ₋₁ become objects to be sensed.

(Practical Example of Information Signal in Embodiment 2)

In the touch panel system 100, as described above, the connection states (i.e., the first connection state and the second connection state) in the touch panel 2 are changed over by the multiplexer 11.

Hereinafter, a drive state of the touch panel 20 in the first connection state (i.e., a state where the number v of horizontal signal lines HL₀ to HLᵥ₋₁ are driven and the number h of vertical signal lines VL₀ to VLₕ₋₁ are sensed) is called a drive state 1.

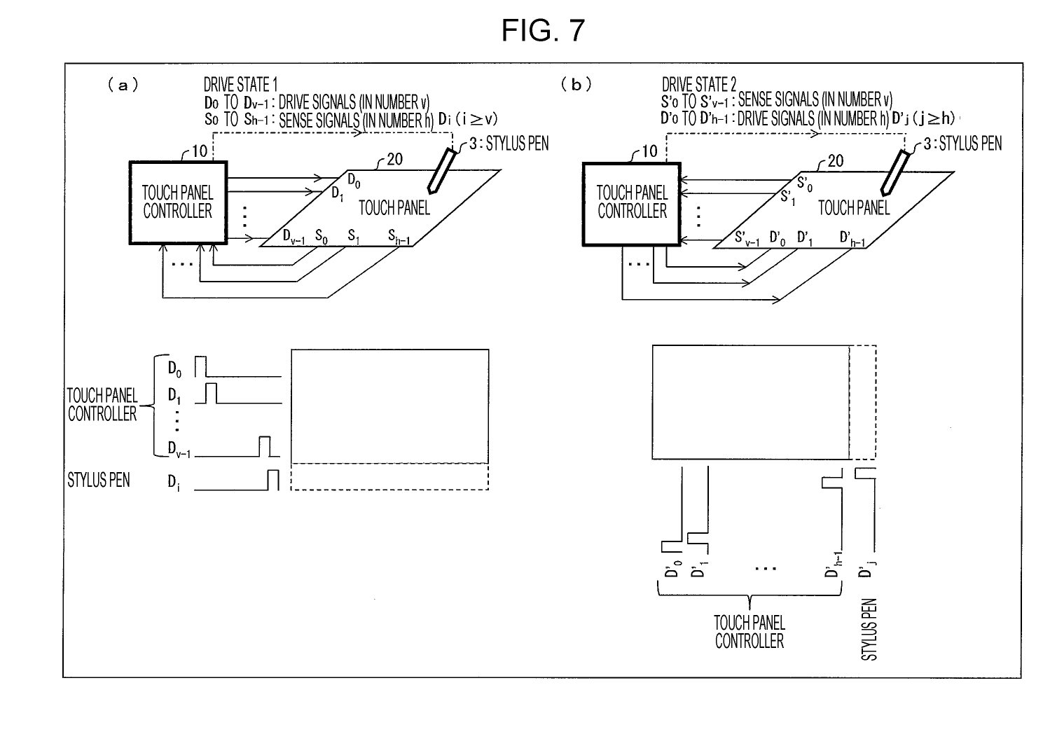

FIG. 7(a) schematically illustrates an operation state of the touch panel system 100 in the drive state 1.

Signals applied to the number v of horizontal signal lines HL₀ to HLᵥ₋₁ driven in the drive state 1 are denoted by drive signals D₀ to Dᵥ₋₁, respectively. Signals sensed from the number h of vertical signal lines VL₀ to VLₕ₋₁ are denoted by sense signals S₀ to Sₕ₋₁, respectively.

In the drive state 1, the driver 22 generates the drive signals D₀ to Dᵥ₋₁. On the other hand, the drive circuit 38 generates a drive signal Dᵢ (i is an integer satisfying i≧v) as the drive signal for driving the pen tip portion 31.

Meanwhile, a drive state of the touch panel 20 in the second connection state (i.e., a state where the number h of vertical signal lines VL₀ to VLₕ₋₁ are driven and the number v of horizontal signal lines HL₀ to HLᵥ₋₁ are sensed) is called a drive state 2.

FIG. 7(b) schematically illustrates an operation state of the touch panel system 100 in the drive state 2.

Signals applied to the number h of vertical signal lines VL₀ to VLₕ₋₁ driven in the drive state 2 are denoted by drive signals D′₀ to D′ₕ₋₁, respectively. Signals sensed from the number v of horizontal signal lines HL₀ to HLᵥ₋₁ are denoted by sense signals S′₀ to S′ᵥ₋₁, respectively.

In the drive state 2, the driver 22 generates the drive signals D′₀ to D′ₕ₋₁. On the other hand, the drive circuit 38 generates a drive signal D′ⱼ (i is an integer satisfying j h) as the drive signal for driving the pen tip portion 31.

Thus, the drive circuit 38 generates (i) the drive signal Dᵢ in the drive state 1, and (ii) the drive signal D′ⱼ in the drive state 2.

It is hence required to transfer, from the touch panel controller 10 to the stylus pen 3, information indicating whether the drive state of the touch panel 20 is in the drive state 1 or the drive state 2.

In consideration of the above point, a signal indicating whether the touch panel 20 is going to be driven in the drive state 1 or the drive state 2 is used as the information signal in this embodiment. As in Embodiment 1, the information signal is generated in the information signal generating unit 19. Moreover, the information signal is detected by the information signal receiving circuit 39.

In this embodiment, the information signal generating unit 19 refers to the signal generated by the timing generator 24 and specifying an operation of the driver 22, thereby recognizing whether the touch panel 20 is going to be driven in the drive state 1 or the drive state 2. The information signal generating unit 19 then generates the information signal on the basis of a result of the recognition.

The information signal in this embodiment may be represented, for example, as (i) a signal “0” in the case of indicating the drive state 1, or (ii) a signal “1” in the case of indicating the drive state 2. As in Embodiment 1, the information signal may be coded with Manchester encoding.

More specifically, the information signal in this embodiment is represented as (i) a signal “000” in the case of indicating the drive state 1, or (ii) a signal “111” in the case of indicating the drive state 2.

FIG. 8(a) illustrates, by way of example, a 3-bit information signal “000” coded with Manchester encoding and indicating the drive state 1, and FIG. 8(b) illustrates, by way of example, a 3-bit information signal “111” coded with Manchester encoding and indicating the drive state 2.

In this embodiment, the timing adjustment circuit 37 refers to the information signal received by the information signal receiving circuit 39, and generates a pen synchronization signal corresponding to the drive signal Dᵢ or the drive signal D′ⱼ.

Therefore, the drive circuit 38 can recognize whether the touch panel 20 is going to be driven in the drive state 1 or the drive state 2, and can generate the drive signal Dᵢ or the drive signal D′ⱼ.

As a result, transmission and reception of the signals between the stylus pen 3 and the touch panel controller 10 can be performed satisfactorily.

(Correspondence Relation in Drive Operations Between Touch Panel Controller 10 and Stylus Pen 3)

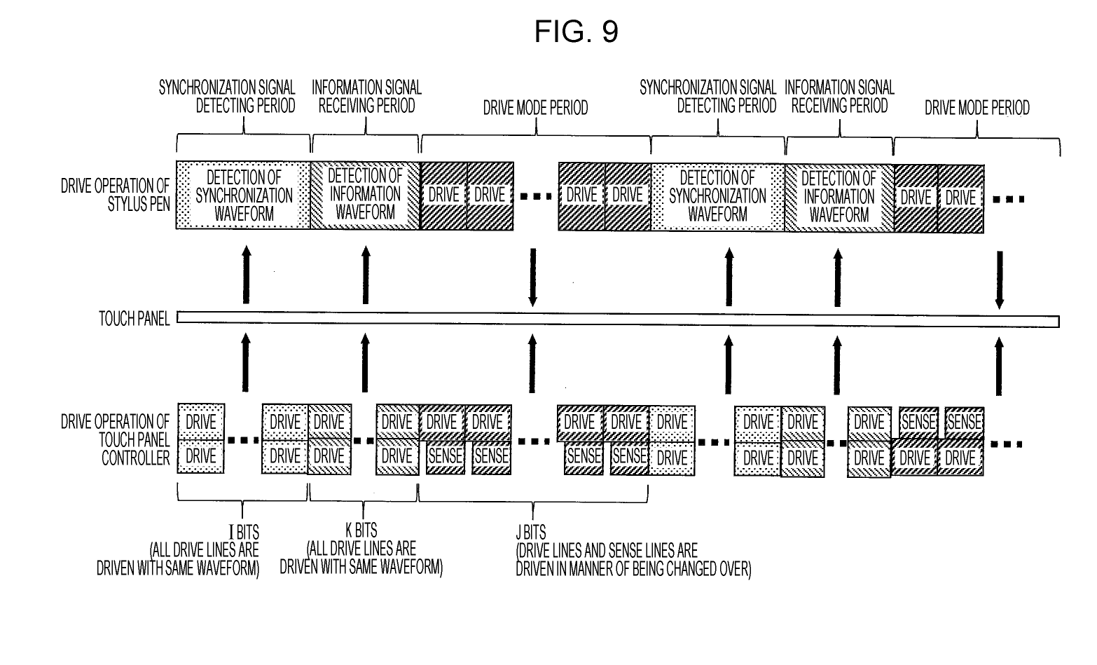

FIG. 9 illustrates correspondence relation between a drive operation of the touch panel controller 10 and a drive operation of the stylus pen 3.

As illustrated in FIG. 9, the drive operation of the stylus pen 3 is constituted by repeating three periods, i.e., (i) a synchronization signal detecting period, (ii) an information signal receiving period, and (iii) a drive mode period.

First, the synchronization signal detecting period is a period during which the first operation changeover switch 34a is turned on and the second operation changeover switch 34b is turned off to detect the synchronization signal from the touch panel controller 10 by both the sense circuit 35 and the synchronization signal detecting circuit 36.

The synchronization signal detecting period is a period of waiting for detection of a bit pattern that represents the synchronization signal. The synchronization signal detecting period may be understood as a period during which the driving of the pen tip portion 31 is cut off and a pattern of the synchronization signal is detected from a signal waveform applied to the pen tip portion 31.

In the synchronization signal detecting period, the drive lines are all driven with the same waveform. A waveform pattern used here may include a pattern having an autocorrelation characteristic, e.g., an M-sequence.

Next, the information signal receiving period is a period during which the information signal from the touch panel controller 10 is transferred to the information signal receiving circuit 39 in the stylus pen 3. The information signal receiving period may be understood as a period during which the driving of the pen tip portion 31 is cut off and a pattern of the information signal is received from a signal waveform applied to the pen tip portion 31.

In the information signal receiving period, the drive lines are all driven with the same waveform. A waveform pattern used here may include a pattern, e.g., an M-sequence, as in the synchronization signal detecting period.

Next, the drive mode period is a period during which the first operation changeover switch 34a is turned off, the second operation changeover switch 34b is turned on, and the pen tip portion 31 is driven by the drive circuit 38.

The drive mode period may be understood as a period during which the pen tip portion 31 is driven by the drive signal Dᵢ or the drive signal D′ⱼ, which is generated in accordance with the information signal received in the information signal receiving period, while an edge of the driving waveform is finely adjusted to be matched with the driving timing of the touch panel controller 10.

In the drive mode period, the drive circuit 38 is operated in match with the driving timing of the touch panel controller 10. Accordingly, the pen tip portion 31 is driven by the drive signal Dᵢ or D′ⱼ when the detection of the synchronization signal and the information signal has succeeded in the stylus pen 3.

Furthermore, as illustrated in FIG. 9, the drive operation of the touch panel controller 10 is constituted by repeating (i) a period during which the drive lines are driven with the same waveform, and (ii) a period during which the drive lines and the sense lines are driven in a manner of being changed over.

First, the period during which the drive lines are driven with the same waveform is a total period of a synchronization waveform drive period during which the synchronization signal is transferred to the stylus pen 3, and an information waveform drive period during which the information signal is transferred to the stylus pen 3.

Next, the period during which the drive lines and the sense lines are driven in a manner of being changed over is an ordinary drive period for position detection to obtain data corresponding to one entire surface of the touch panel 2.

More specifically, in the ordinary drive period, the touch panel controller repeats operations of driving the individual drive lines in accordance with a waveform (waveform for touch detection) that is necessary to detect a touch position by the stylus pen 3, and operations of sensing the individual sense lines.

A method for driving the drive lines in the ordinary drive period may be implemented with a sequential driving or parallel driving technique. FIGS. 8(a) and 8(b) illustrate, by way of example, the case of sequential driving for the sake of simplicity.

(Advantageous Effect of Touch Panel System 100)

The information signal in the touch panel system 100 of this embodiment is the signal indicating whether the touch panel 20 is going to be driven in the drive state 1 or the drive state 2.

Accordingly, this embodiment has an advantageous effect that the drive state of the stylus pen 3 can be set corresponding to changeover of the drive state of the touch panel controller 10 (i.e., changeover between the drive state 1 and the drive state 2) by applying the information signal to the stylus pen 3.

[Modifications]

Embodiments 1 and 2 have been described above, by way of example, in connection with the case of providing the information signal as a signal of N bits (N≧3) having equal values, and executing the error correction of the information signal on the basis of the rule of majority. However, a method of executing the error correction of the information signal is not necessarily limited to a technique on the basis of the rule of majority.

For example, the information signal generating unit 19 may generate, in addition to the information signal, an error correction signal to execute the error correction of the information signal. In such a case, the information signal receiving circuit 39 receives the information signal and the error correction signal from the information signal generating unit 19.

Accordingly, the information signal receiving circuit 39 can execute the error correction of the information signal by referring to the error correction signal. The error correction signal may be, e.g., a parity bit (parity code) suffixed to the information signal of N bits.

The error correction signal is not limited to the parity bit, and other signals known in the field of error detection and correction may be optionally used. For example, CRC (Cyclic Redundancy Check) code, Hamming code, or a hash function may be used to provide the error correction signal.

The touch panel controllers in above Embodiments 1 and (i.e., the touch panel controllers 4 and 10) may be each implemented in the form of an integrated circuit (IC). Thus, an integrated circuit including the functions of the touch panel controller 4 or 10 also falls within the technical scope of the present invention.

While Embodiments 1 and 2 have been described above on the assumption of using the touch panel of the electrostatic capacitance type (i.e., the touch panel 2 or 20), the present invention is not limited to the touch panel of the electrostatic capacitance type. The present invention may be applied to a touch panel of another type capable of reading signal values as a matrix pattern from sensors that are disposed on the touch panel (e.g., a touch panel of resistance film type capable of reading a plurality of electrical resistance values distributed in a matrix pattern).

### Embodiment 3

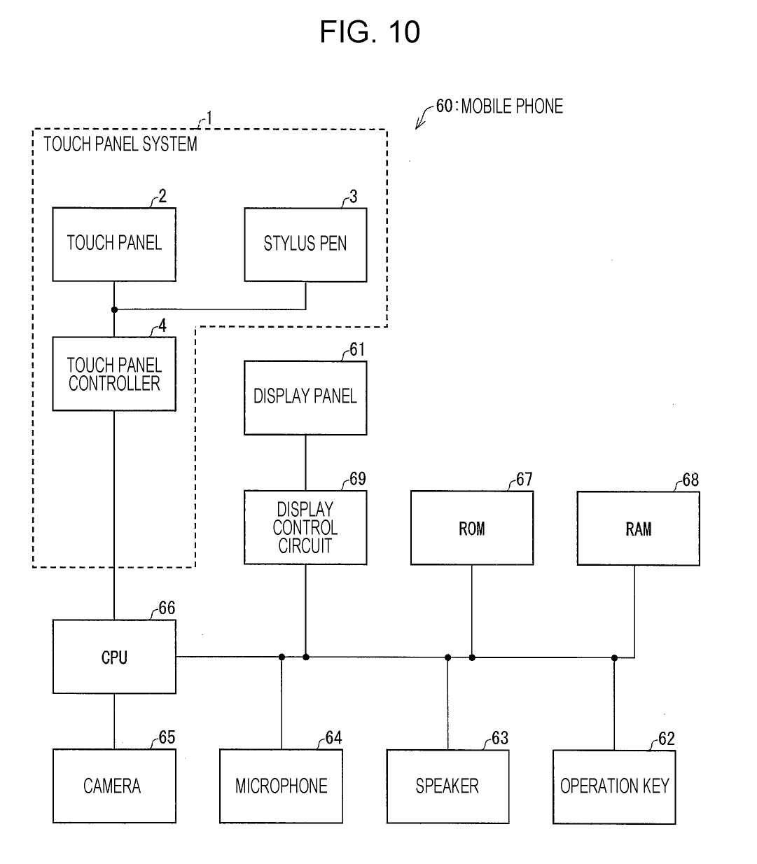

Still another embodiment of the present invention will be described below with reference to FIG. 10. For the sake of convenience in explanation, members having the same functions as the members described in the above embodiments are denoted by the same reference signs, and description of those members is omitted.

FIG. 10 is a functional block diagram illustrating a configuration of a mobile phone 60 (electronic device) as one example of an electronic device including the touch panel system 1 according to Embodiment 1. While Embodiment 3 employs, by way of example, the configuration that the touch panel system 1 according to Embodiment 1 is disposed in the mobile phone 60, the touch panel system 100 according to Embodiment 2 may be disposed in the mobile phone 60.

The mobile phone 60 includes the touch panel system 1, a display panel 61, an operation key 62, a speaker 63, a microphone 64, a camera 65, a CPU (Central Processing Unit) 66, a ROM (Read Only Memory) 67, a RAM (Random Access Memory) 68, and a display control circuit 69. Those components of the mobile phone 60 are interconnected via a data bus.

As described above, the touch panel system 1 includes the touch panel 2, the stylus pen 3, and the touch panel controller 4.

The display panel 61 displays an image stored in the ROM 67 or the RAM 68. An operation of the display panel 61 is controlled by the display control circuit 69.

The display panel 61 may be provided in a state overlying the touch panel 2 or incorporating the touch panel 2. A touch recognition signal generated by the touch recognizing unit 17 and representing the touch position on the touch panel 2 may be given with the same role as a signal indicating that the operation key 62 has been operated.

The operation key 62 receives an input operation made by a user of the mobile phone 60. The speaker 63 outputs, e.g., sounds in accordance with music data stored in the ROM 67 or the RAM 68.

The microphone 64 receives an input of voice from the user. The mobile phone 60 converts the input voice (analog data) to digital data. Then, the mobile phone 60 transmits digitized voice to a communication partner (e.g., another mobile phone).

The camera 65 takes an image of an object in response to an input operation made by the user on the operation key 62, and generates image data. The image data is stored in the ROM 67, the RAM 68, or an external memory (e.g., a memory card).

The CPU 66 controls the operations of the touch panel system 1 and the mobile phone 60 in a supervising manner. Furthermore, the CPU 66 runs various programs stored in the ROM 67, for example.

The ROM 67 stores data in a non-volatile manner. The ROM 67 is a writable and erasable ROM, such as an EPROM (Erasable Programmable ROM) or a flash memory. Though not illustrated in FIG. 10, the mobile phone 60 may include an interface for connection to another electronic device through a wire.

The RAM 68 stores, in a volatile manner, data generated with the CPU 66 running the programs, or data input through the operation key 62.

The mobile phone 60 including the touch panel system 1 also has a similar advantageous effect to that obtained with the touch panel system 1 according to Embodiment 1.

While, in this embodiment, the mobile phone 60 as one example of the electronic derive including the touch panel system 1 is, e.g., a camera-equipped mobile phone or a smartphone, the electronic derive including the touch panel system 1 is not limited to that example. As other examples, a portable terminal device such as a tablet, and an information processing device such as a PC monitor, a signage, an electronic blackboard, or an information display also fall within the scope of the electronic derive including the touch panel system 1.

[Recapitulation]

According to a first aspect of the present invention, there is provided a touch panel controller (4) for driving a touch panel (2), the touch panel being given with an input operation by a stylus pen (3) that is able to transmit and receive information to and from the touch panel controller via wireless communication, the touch panel controller including a synchronization signal generating unit (timing generator 14) that generates a synchronization signal to synchronize drive timing of the stylus pen and drive timing of the touch panel with each other, and an information signal generating unit (19) that generates an information signal representing a drive state of the touch panel, wherein the information signal is transferred from the touch panel controller to the stylus pen subsequent to the synchronization signal.

With the features described above, the stylus pen can be operated in synchronization with the drive timing of the touch panel by applying the synchronization signal, which has been generated by the synchronization signal generating unit, to the stylus pen from the touch panel controller.

Furthermore, the stylus pen can be caused to recognize the drive state of the touch panel by applying the information signal, which has been generated by the information signal generating unit, to the stylus pen from the touch panel controller.

Therefore, a drive state of the stylus pen can be set corresponding to the drive state of the touch panel controller by employing the information signal.

Moreover, since the information signal is transferred from the touch panel controller to the stylus pen subsequent to the synchronization signal, the stylus pen can be operated to detect the information signal at proper timing by causing the stylus pen to start an operation of detecting the information signal with a trigger released upon detection of the synchronization signal by the stylus pen.

In addition, information is transferred from the touch panel controller to the stylus pen via wireless communication. Therefore, an advantageous effect is obtained in that the driving of the stylus pen can be satisfactorily controlled without connecting the touch panel controller and the stylus pen through a cable.

According to a second aspect of the present invention, in the touch panel controller according to the first aspect, the touch panel preferably includes first signal lines (horizontal signal lines HL₀ to HL_{K-1}) and second signal lines (vertical signal lines VL₀ to V_{L-1}) that are driven by the touch panel controller to be capable being changed over, and the information signal is preferably a signal indicating which ones of the first signal lines and the second signal lines are going to be driven.

With the features described above, the stylus pen can recognize the changeover of the drive state of the touch panel by applying the information signal to the stylus pen. Therefore, an advantageous effect is obtained in that the drive state of the stylus pen 3 can be set corresponding to the changeover of the drive state of the touch panel controller.

According to a third aspect of the present invention, in the touch panel controller according to the first or second aspect, the information signal is preferably coded with Manchester encoding.

With the feature described above, an advantageous effect is obtained in that the information signal can be appropriately transferred via wireless communication.

According to a fourth aspect of the present invention, in the touch panel controller according to any one of the first to third aspects, the information signal is preferably a signal of three or more bits having equal values.

With the feature described above, an advantageous effect is obtained in that error correction of the information signal can be performed by applying the rule of majority to the bits of the information signal.

According to a fifth aspect of the present invention, in the touch panel controller according to any one of the first to fourth aspects, the information signal generating unit preferably further generates an error correction signal to correct an error of the information signal.

With the feature described above, an advantageous effect is obtained in that the error correction of the information signal can be performed by referring to the error correction signal.

According to a sixth aspect of the present invention, there is provided a stylus pen for applying an input operation to a touch panel, the touch panel being driven by a touch panel controller, the stylus pen being able to transmit and receive information to and from the touch panel controller via wireless communication, the stylus pen including a synchronization signal detecting unit (synchronization signal detecting circuit 36) that detects a synchronization signal to synchronize drive timing of the stylus pen and drive timing of the touch panel with each other, and an information signal detecting unit (information signal receiving circuit 39) that detects an information signal representing a drive state of the touch panel, wherein the synchronization signal and the information signal are generated by the touch panel controller, and the information signal is transferred from the touch panel controller to the stylus pen subsequent to the synchronization signal.

With the features described above, since the synchronization signal detecting unit and the information signal detecting unit are disposed in the stylus pen, the synchronization signal and the information signal generated by the touch panel controller can be detected by the stylus pen.

Thus, as in the above-described the touch panel controller according to the first aspect of the present invention, an advantageous effect is obtained in that the driving of the stylus pen can be satisfactorily controlled without connecting the touch panel controller and the stylus pen through a cable.

According to a seventh aspect of the present invention, in the touch panel controller according to the sixth aspect, the information signal detecting unit preferably has a function of correcting an error of the information signal.

With the feature described above, an advantageous effect is obtained in that the error correction of the information signal can be performed by the stylus pen.

An integrated circuit according to an eighth aspect of the present invention preferably includes the functions of the touch panel controller according to any one of the first to fifth aspects.

With the feature described above, an advantageous effect is obtained in that the touch panel controller according to one of the above aspects of the present invention can be implemented in the form of an integrated circuit.

According to a ninth aspect of the present invention, there is provided a touch panel system (1) including the touch panel controller according to any one of the first to fifth aspects, a touch panel driven by the touch panel controller, and a stylus pen being able to apply an input operation to the touch panel and to transmit and receive information to and from the touch panel controller via wireless communication, wherein the stylus pen includes a synchronization signal detecting unit that detects the synchronization signal, and an information signal detecting unit that detects the information signal.

With the features described above, an advantageous effect is obtained in that the touch panel system including the touch panel controller according to one of the above aspects of the present invention, the stylus pen, and the touch panel can be achieved.

An electronic device (mobile phone 60) according to a tenth aspect of the present invention preferably includes the touch panel system according to the ninth aspect.

With the feature described above, an advantageous effect is obtained in that the electronic device including the touch panel system according to one aspect of the present invention can be achieved.

[Supplemental Statement]

The present invention is not limited to the above-described embodiments, and the present invention can be modified in various ways within the scope defined in Claims. Other embodiments obtained by appropriately combining the technical means disclosed in the different embodiments with each other also fall within the technical scope of the present invention. Furthermore, novel technical features can be obtained by combining the technical means disclosed in the different embodiments.

Alternatively, the present invention can also be expressed as follows.

A touch panel system according to one aspect of the present invention includes a touch panel having electrostatic capacitances that are formed at intersect points between a plurality of first signal lines and a plurality of second signal lines, a touch pen, and a touch panel controller, the touch panel controller repetitively performing an changeover operation of driving the plurality of first signal lines to output charge signals on the basis of the individual electrostatic capacitances from the second signal lines during a first signal line drive period and driving the plurality of second signal lines to output charge signals on the basis of the individual electrostatic capacitances from the first signal lines during a second signal line drive period, the touch pen being touched to the touch panel during the repetitive changeover operation of the touch panel controller to detect a touch position on the basis of change of the electrostatic capacitance caused upon touching by the touch pen, wherein the touch pen is constituted as an electronic pen allowing signals to be input and output to the electronic pen, wherein the touch panel controller includes a synchronization signal transmitting unit that transmits a synchronization signal to the electronic pen in a synchronization signal transmitting period immediately before each of the first signal line drive period and the second signal line drive period, and an information signal transmitting unit that transmits an information signal to the electronic pen in an information signal transmitting period immediately after the synchronization signal transmitting period, wherein the synchronization signal transmitting unit transmits the synchronization signal, which has a periodic waveform in a pseudo-irregular sequence coded with Manchester encoding, to the electronic pen in the synchronization signal transmitting period, wherein the information signal transmitting unit transmits the information signal of arbitrary N bits, which is to be transferred from the touch panel controller to the electronic pen, in the information signal transmitting period, and wherein the electronic pen includes a synchronization signal detecting unit that detects the synchronization signal, and an information signal receiving unit that receives the information signal.

### INDUSTRIAL APPLICABILITY

The present invention can be utilized in a touch panel controller and a stylus pen.

### REFERENCE SIGNS LIST

1, 100 touch panel system
2, 20 touch panel
3 stylus pen
4, 10 touch panel controller
14, 24 timing generator (synchronization signal generating unit)
19 information signal generating unit
36 synchronization signal detecting circuit (synchronization signal detecting unit)
39 information signal receiving circuit (information signal detecting unit)
60 mobile phone (electronic device)
HL₀ to HL_{K-1} horizontal signal lines (first signal lines)
VL₀ to VL_{L-1} vertical signal lines (second signal lines)

1. A touch panel controller for driving a touch panel,
the touch panel being given with an input operation from a stylus pen that is able to transmit and receive information to and from the touch panel controller via wireless communication,
the touch panel controller comprising:
a synchronization signal generating unit that generates a synchronization signal to synchronize drive timing of the stylus pen and drive timing of the touch panel with each other; and
an information signal generating unit that generates an information signal representing a drive state of the touch panel,
wherein the information signal is transferred from the touch panel controller to the stylus pen subsequent to the synchronization signal.

2. The touch panel controller according to claim 1, wherein the touch panel includes first signal lines and second signal lines that are driven by the touch panel controller in a manner capable of being changed over, and
the information signal is a signal indicating which ones of the first signal lines and the second signal lines are going to be driven.

3. A stylus pen for applying an input operation to a touch panel,
the touch panel being driven by a touch panel controller,
the stylus pen being able to transmit and receive information to and from the touch panel controller via wireless communication,
the stylus pen comprising:
a synchronization signal detecting unit that detects a synchronization signal to synchronize drive timing of the stylus pen and drive timing of the touch panel with each other; and
an information signal detecting unit that detects an information signal representing a drive state of the touch panel,
wherein the synchronization signal and the information signal are generated by the touch panel controller, and
the information signal is transferred from the touch panel controller to the stylus pen subsequent to the synchronization signal.

4. A touch panel system comprising:
the touch panel controller according to claim 1;
a touch panel driven by the touch panel controller; and
a stylus pen being able to apply an input operation to the touch panel and to transmit and receive information to and from the touch panel controller via wireless communication,
wherein the stylus pen includes a synchronization signal detecting unit that detects the synchronization signal, and an information signal detecting unit that detects the information signal.

5. An electronic device including the touch panel system according to claim 4.
